(19) United States
(12) Patent Application Publication
(10) Pub. No.: US 2020/0252387 A1
(43) Pub. Date: Aug. 6, 2020

(54) ACCESSING A CONTROL PLATFORM

(71) Applicant: Hewlett Packard Enterprise Development LP, Houston, TX (US)

(72) Inventors: Jaivish Kothari, Bangalore (IN); Kiran Kumar Vaddi, Bangalore (IN)

(21) Appl. No.: 16/263,560

(22) Filed: Jan. 31, 2019

(51) Int. Cl. H04L 29/06; G06F 21/62; G06F 8/71; G06F 8/73

(52) U.S. Cl. CPC H04L 63/0815; H04L 63/10; G06F 8/73; G06F 8/71; G06F 21/6227

(57) ABSTRACT

Example implementations relate to accessing a control platform. A computing device may comprise a processing resource and a memory resource storing non-transitory machine-readable instructions to cause the processing resource to receive an access request for a control platform of a plurality of control platforms, access the control platform based on the received access request, and transmit access description information based on an action performed with the control platform.

### BACKGROUND

During development of computer software, different versions of the computer readable instructions comprising the software may be generated. For example, there may be multiple programmers who may be concurrently working on the computer program and/or software. A control platform can manage various changes to the computer readable instructions comprising the software.

### BRIEF DESCRIPTION OF THE DRAWINGS

FIG. 1 illustrates an example system consistent with the disclosure.

FIG. 2A illustrates an example system having plugins consistent with the disclosure.

FIG. 2B illustrates an example system having webhooks consistent with the disclosure.

FIG. 3 is a block diagram of an example computing device for accessing a control platform consistent with the disclosure.

FIG. 4 is a block diagram of an example system consistent with the disclosure.

FIG. 5 illustrates an example method consistent with the disclosure.

### DETAILED DESCRIPTION

Control platforms can provide various services to users. As used herein, the term “control platform” can, for example, refer to a management service that manages changes to documents, computer programs, computer readable instructions, websites, and/or other collections of information that may be useful in relation to generating computer readable instructions. For example, during development of a piece of software, many different programmers may be involved during various stages of creation, and a control platform can provide management services during the creation of the software. As used herein, the term “software” can, for example, refer to a set of instructions that are executed by a processor to perform a task. For example, the software can be a set of non-transitory machine-readable instructions that are executed by a processor to perform a coordinated function, task, and/or activity.

There may be different control platforms which can offer different types of services. For example, during development of the software, one particular control platform may be useful whereas later in the development of the software, a different control platform may be useful.

Many different control platforms can exist with which a user may be associated. For example, a user can have an account with multiple different control platforms. Each account may include its own login credentials. This can lead to a user having to manage many different control platform accounts separately. As a result, the user has to manually manage each different account.

In some examples, an administrator of a corporate account has to manually add each user's login credentials for each account to a repository for account management. As a result, every user access request/action performed with the control platform may be done via administrator intervention. Further, public login credential repositories may not be added to repositories hosted on private corporate networks. Moreover, an approach utilizing corporate accounts may limit any user access request/action performed with the control platform to server-side changes. Accordingly, maintaining and executing such approaches can be cumbersome.

Accessing a control platform, according to the disclosure, can allow for a single unified way to manage user access requests/actions performed with different control platforms. For example, a user can seamlessly manage and/or perform actions on different control platforms from a single portal. Accessing a control platform according to the disclosure can save on resources and effort relating to management of different user accounts across varying control platforms.

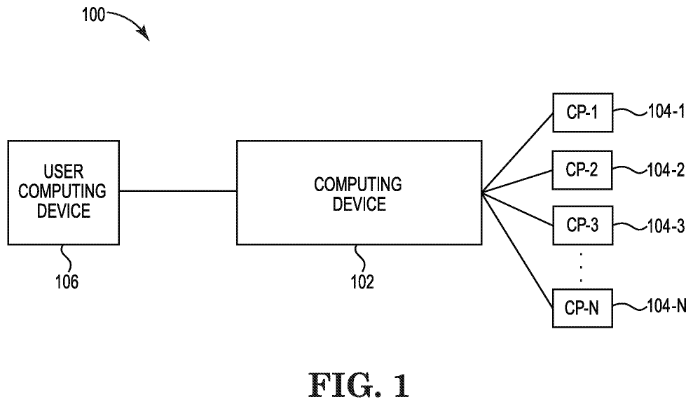

FIG. 1 illustrates an example system 100 consistent with the disclosure. As illustrated in FIG. 1, the system 100 can include computing device 102, control platforms 104-1, 104-2, 104-3, 104-N (referred to collectively herein as control platforms 104 and illustrated in FIG. 1 as “CP-1” through “CP-N”), and user computing device 106.

System 100 can include computing device 102 and user computing device 106. As used herein, the term “computing device” can, for example, refer to a device including a processor, memory, and input/output interfaces for wired and/or wireless communication. A computing device may include a laptop computer, a desktop computer, a mobile device, and/or other wireless devices, although examples of the disclosure are not limited to such devices. A mobile device may refer to devices that are (or may be) carried and/or worn by a user. For instance, a mobile device can be a phone (e.g., a smart phone), a tablet, a personal digital assistant (PDA), smart glasses, and/or a wrist-worn device (e.g., a smart watch), among other types of mobile devices.

Computing device 102 can be utilized for accessing a control platform. For example, computing device 102 can be utilized to access a control platform 104 based on a received access request (e.g., from user computing device 106). For example, as described above, a user may make a change to computer readable instructions of a piece of software, get a status of a change, update a change, among other actions, and can access any one of control platforms 104 in order to do so, as is further described herein.

Computing device 102 can receive an access request for a control platform 104. As used herein, the term “access request” can, for example, refer to a call to connect to a control platform in order to perform an action. For example, a user may desire to perform an action such as make a change to computer readable instructions comprising software and can initiate the change to the computer readable instructions via an access request to a control platform 104.

Although an action performed with control platform 104 is described above as including a change to computer readable instructions comprising software, examples of the disclosure are not so limited. For example, an action can include any other operation with respect to the control platforms 104, as is further described herein.

As described above, a user may have multiple accounts on different control platforms. For example, a user may have an account on control platform 104-1, 104-2, and 104-3. In some examples, a user may desire to make a change to software via control platform 104-1. The user can, utilizing user computing device 106, transmit an access request to computing device 102 for control platform 104-1 in order to begin the process to effectuate the change to the software, as is further described herein.

Control platforms 104 can be source control platforms. As used herein, the term “source control platform” can, for example, refer to a management service to track a source of changes to documents, computer programs, computer readable instructions, websites, and/or other collections of information. For example, a source control platform can manage the sources of changes to computer readable instructions comprising software among multiple different users.

In some examples, the source control platforms can be public source control platforms. As used herein, the term “public source control platform” can, for example, refer to a publicly available source control platform. For example, any user can create an account and utilize a public source control platform for source management of documents, computer programs, computer readable instructions, websites, and/or other collections of information.

In some examples, the source control platforms can be private source control platforms. As used herein, the term “private source control platform” can, for example, refer to a source control platform that is available to select users. For example, a private source control platform may be available within a corporate structure and select users may be employees or agents of the corporation such that the select users can utilize the private source control platform for source management of documents, computer programs, computer readable instructions, websites, and/or other collections of information.

In some examples, control platforms 104 can be version control platforms. As used herein, the term “version control platform” can, for example, refer to a management service to track changes to documents, computer programs, computer readable instructions, websites, and/or other collections of information. For example, a version control platform can manage different versions of computer readable instructions comprising software among multiple different users making various changes to the software.

In some examples, the version control platforms can be public version control platforms. As used herein, the term “public version control platform” can, for example, refer to a publicly available version control platform. For example, any user can create an account and utilize a public version control platform for version management of documents, computer programs, computer readable instructions, websites, and/or other collections of information.

In some examples, the version control platforms can be private version control platforms. As used herein, the term “private version control platform” can, for example, refer to a version control platform that is available to select users. For example, a private version control platform may be available within a corporate structure and select users may be employees or agents of the corporation such that the select users can utilize the private version control platform for version management of documents, computer programs, computer readable instructions, websites, and/or other collections of information.

Examples of control platforms can include, for instance, GitHub, Gerrit, and/or Concurrent Versions System (CVS), although examples of control platforms are not so limited. For example, control platforms can be any other source/version control platform.

Although control platforms 104 are described above as being source control or version control platforms as well as being public or private control platforms, examples of the disclosure are not so limited. For example, control platforms 104 can be any combination thereof (e.g., public and/or private source control platforms and/or public and/or private version control platforms).

As described above, computing device 102 can receive an access request (e.g., from user computing device 106). The access request can include a particular control platform among the control platforms 104 to which an action is to be performed. For example, a user of user computing device 106 can transmit an access request to computing device 102 specifying an action to be performed using control platform 104-1.

Further included in the access request can be a user identity. As used herein, the term “user identity” can, for example, refer to information to distinguish one thing from another. For example, a user identity can include a username and/or a password. The username and/or password can identity a first user who is distinct from a second and/or other users, where the first user is the user sending the access request.

Although identifying information is described above as including a username and/or password, examples of the disclosure are not so limited. For example, identifying information can be other information identifying a user of computing device 106 (e.g., fingerprint, eye scan, spoken passcode, etc.), information identifying the user computing device 106 itself (e.g., a MAC address, IP address, etc.), and/or combinations thereof, among other types of identifying information.

Computing device 102 can compare the user identity in the access request with user access credentials. As used herein, the term “user access credentials” can, for example, refer to information entitling a user to certain privileges. For example, user access credentials can include the user's username, password, identifying information of the user of user computing device 106, information identifying the user computing device 106 itself, and/or combinations thereof, among other types of user access credentials. For example, user computing device 106 can transmit an access request to computing device 102 including an input username and password; computing device 102 can compare the input user name and password with a stored username and password.

Computing device 102 can access the control platform 104 based on the received access request and the user identity matching the user access credentials. Continuing with the example from above, computing device 102 can receive the access request and, based on the user identity (e.g., the entered username and password included with the access request) matching user access credentials (e.g., a stored username and password), computing device 102 can access a control platform 104 (e.g., control platform 104-1, specified in the access request).

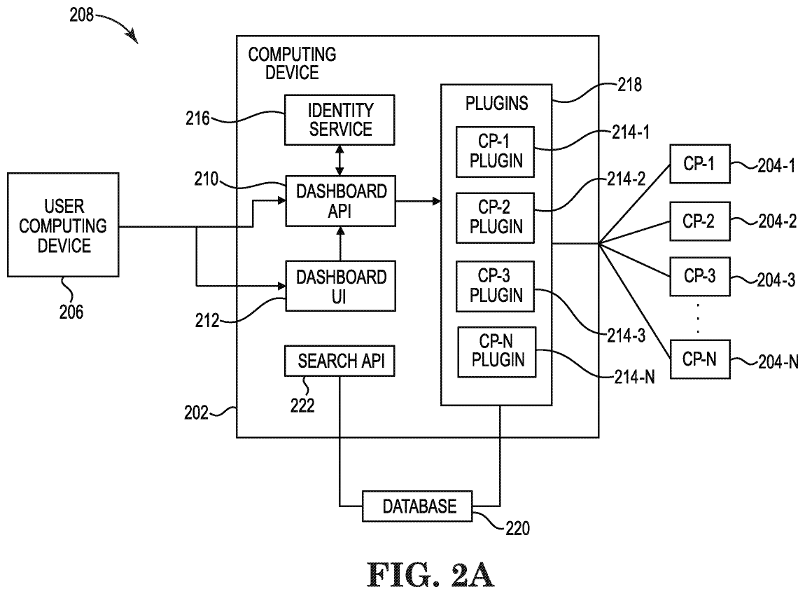

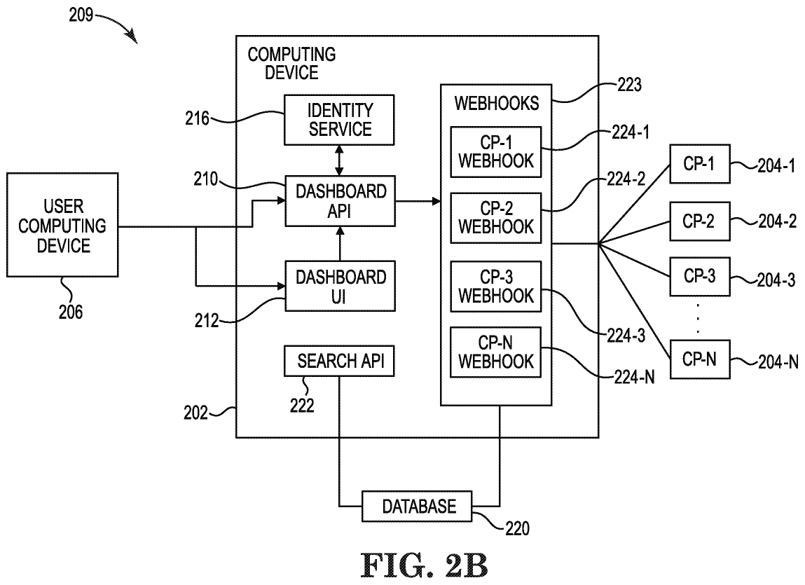

In some examples, computing device 102 can access control platform 104 via a plugin. As used herein, term “plugin” can, for example, refer to a software component that adds a feature to an existing computer program. For example, computing device 102 can access a control platform 104 via an added feature of a computer program, as is further described in connection with FIG. 2A.

In some examples, computing device 102 can access control platform 104 via a webhook. As used herein, the term “webhook” can, for example, refer to a method of augmenting behavior of an application with a callback. For example, computing device 102 can access a control platform 104 via augmenting behavior of a computer program, as is further described in connection with FIG. 2B.

Accessing the control platform by the computing device 102 can include performing a create, read, update, or delete (CRUD) operation. For example, computing device 102 can show activities of the control platform 104, create a change request (e.g., create a pull request, patch, code change, etc.), get a status of a change request, delete a change request, and/or update a change request, among other operations. For instance, computing device 102 can create a change request to change computer readable instructions of software.

Computing device 102 can transmit access description information based on an action performed with control platform 104. As used herein, the term “access description information” can, for example, refer to details describing actions taken when accessing a control platform 104. For example, following the change request described in the example above, computing device 102 can transmit access description information detailing the change request. Computing device 102 can transmit access description information to user computing device 106, and/or to other locations.

Computing device 102 can store the access description information in a database. The access description information can be stored in a database for later reference, and may be stored for performance optimization, as is further described in connection with FIGS. 2A and 2B.

A user can view the above described process via a user interface (UI). As used herein, the term “UI” can, for example, refer to an interface that can provide and/or receive information and/or from a user of a computing device. In some examples, a user interface can be a graphical user interface included on, for instance, a display, a touch-screen display, etc. A display can include a television, computer monitor, mobile device screen, other type of display device, and/or any combination thereof. For example, a user can utilize a UI to access different control platforms 104 from a single UI.

Accessing a control platform, according to the disclosure, can allow a user to access different control platforms via a single interface. The user can access different control platforms without having to manage different login credentials for different accounts included on the different control platforms. Further, in some examples such as in the case of corporate accounts, management of many different select users which have access to the control platforms by way of the corporate accounts can be streamlined, allowing for reduced management costs.

FIG. 2A illustrates an example system 208 having plugins 218 consistent with the disclosure. As illustrated in FIG. 2A, the system 208 can include computing device 202, control platforms 204-1, 204-2, 204-3, 204-N (referred to collectively herein as control platforms 204 and illustrated in FIG. 2A as “CP-1” through “CP-N”), user computing device 206, and database 220. Computing device 202 can include a dashboard application programming interface (API) 210, dashboard user interface (UI) 212, identity service 216, control platform plugins 218, and search API 222. Control platform plugins 218 can include control platform plugins 214-1, 214-2, 214-3, 214-N (illustrated in FIG. 2A as “CP-1 Plugin” through “CP-N Plugin”).

As previously described in connection with FIG. 1, computing device 202 can receive an access request from user computing device 206. The access request can include a control platform 204 to which an action is to be performed, as well as a user identity.

In some examples, computing device 202 can receive the access request via an API. As used herein, the term “API” can, for example, refer to a set of subroutine definitions, communication protocols, and tools for software. For example, user computing device 206 can transmit an access request and perform actions using control platforms 204 by sending API commands through the dashboard API 210. For instance, computing device 206 can transmit Linux commands to dashboard API 210 in order to access control platforms 204, although examples of the disclosure are not limited to Linux commands.

In some examples, computing device 202 can receive the access request via a UI. For example, a user can interact with the dashboard UI 212 to input commands in order to access/perform actions using control platforms 204.

Once computing device 202 has received the access request, computing device 202 can verify a user identity included in the access request. Computing device 202 can verify the user identity via identity service 216. For example, identity service 216 can compare the user identity included in the received access request with user access credentials. In response to the user identity matching the user access credentials, computing device 202 can access control platform 204, as is further described herein.

Computing device 202 can access a control platform via a plugin 218. For example, computing device 202 can receive an access request for control platform 204-2. Computing device 202 can access control platform 204-2 via plugin 214-2. In other words, computing device 202 can include plugins 218 where each plugin corresponds to a control platform 204. For example, as illustrated in FIG. 2A, plugin 214-1 corresponds to control platform 204-1, plugin 214-2 corresponds to control platform 204-2, plugin 214-3 corresponds to control platform 204-3, and plugin 214-N corresponds to control platform 204-N.

Accessing the control platform can include performing a CRUD operation. Continuing with the example above, based on the access request, computing device 202 can access control platform 204-2 and cause a CRUD operation to be performed using control platform 204-2. For example, computing device 202 can create a change request (e.g., create a pull request, patch, code change, etc.), get a status of a change request, delete a change request, and/or update a change request, among other operations using control platform 204-2.

Computing device 202 can store access description information in database 220. As previously described in connection with FIG. 1, access description information can include details describing actions taken when accessing a control platform 204. For instance, computing device 202 can create a change request with control platform 204-2, and computing device 202 can store the created change request in database 220.

In some examples, computing device 202 can access the stored access description information in the database 220. For example, in response to computing device 202 receiving a further access request that is the same as a previous access request, computing device 202 can access the stored access description information in database 220. For instance, computing device 202 can receive a further access request to create a pull request for control platform 204-2; computing device 202 can receive the further access request via search API 222 and access database 220. By utilizing database 220 rather than again accessing control panel 204-2, computing device 202 can save on computing resources and increase performance rather than continuously making plugin calls to control platform 204-2.

FIG. 2B illustrates an example system 209 having webhooks 223 consistent with the disclosure. As illustrated in FIG. 2B, the system 209 can include computing device 202, control platforms 204-1, 204-2, 204-3, 204-N (referred to collectively herein as control platforms 204 and illustrated in FIG. 2B as “CP-1” through “CP-N”), user computing device 206, and database 220. Computing device 202 can include a dashboard application programming interface (API) 210, dashboard user interface (UI) 212, identity service 216, control platform webhooks 223, and search API 222. Control platform webhooks 223 can include control platform webhooks 224-1, 224-2, 224-3, 224-N (illustrated in FIG. 2B as “CP-1 Webhook” through “CP-N Webhook”).

As previously described in connection with FIG. 1, computing device 202 can receive an access request from user computing device 206. The access request can include a control platform 204 to which an action is to be performed, as well as a user identity.

In some examples, computing device 202 can receive the access request via an API. As used herein, the term “API” can, for example, refer to a set of subroutine definitions, communication protocols, and tools for software. For example, user computing device 206 can transmit an access request and perform actions using control platforms 204 by sending API commands through the dashboard API 210. For instance, computing device 206 can transmit Linux commands to dashboard API 210 in order to access control platforms 204, although examples of the disclosure are not limited to Linux commands.

In some examples, computing device 202 can receive the access request via a UI. For example, a user can interact with the dashboard UI 212 to input commands in order to access/perform actions using control platforms 204.

Once computing device 202 has received the access request, computing device 202 can verify a user identity included in the access request. Computing device 202 can verify the user identity via identity service 216. For example, identity service 216 can compare the user identity included in the received access request with user access credentials. In response to the user identity matching the user access credentials, computing device 202 can access control platform 204, as is further described herein.

Computing device 202 can access a control platform via a webhook 223. For example, computing device 202 can receive an access request for control platform 204-2. Computing device 202 can access control platform 204-2 via webhook 224-2. In other words, computing device 202 can include webhooks 223 where each webhook corresponds to a control platform 204. For example, as illustrated in FIG. 2B, webhook 224-1 corresponds to control platform 204-1, webhook 224-2 corresponds to control platform 204-2, webhook 224-3 corresponds to control platform 204-3, and webhook 224-N corresponds to control platform 204-N.

Accessing the control platform can include performing a CRUD operation. Continuing with the example above, based on the access request, computing device 202 can access control platform 204-2 and cause a CRUD operation to be performed using control platform 204-2. For example, computing device 202 can create a change request (e.g., create a pull request, patch, code change, etc.), get a status of a change request, delete a change request, and/or update a change request, among other operations using control platform 204-2.

Similar to the examples described in FIG. 2A, computing device 202 can store access description information in database 220. For instance, computing device 202 can create a change request with control platform 204-2, and computing device 202 can store the created change request in database 220. Similarly, computing device 202 can access the stored access description information in the database 220. For example, in response to computing device 202 receiving a further access request that is the same as a previous access request, computing device 202 can access the stored access description information in database 220. For instance, computing device 202 can receive a further access request to create a pull request for control platform 204-2; computing device 202 can receive the further access request via search API 222 and access database 220.

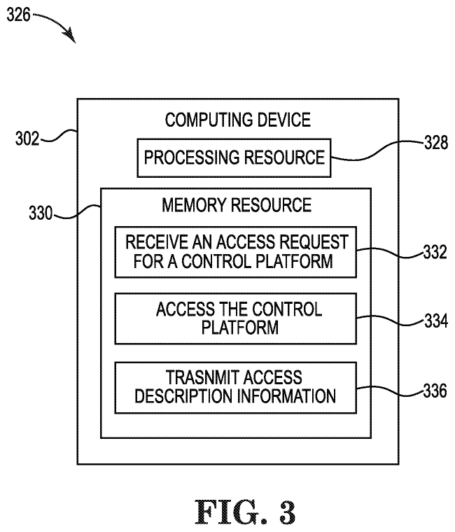

FIG. 3 is a block diagram 326 of an example computing device 302 for accessing a control platform consistent with the disclosure. As described herein, the computing device 302 may perform a number of functions related to accessing a control platform. Although not illustrated in FIG. 3, the computing device 302 may include a processor and a machine-readable storage medium. Although the following descriptions refer to a single processor and a single machine-readable storage medium, the descriptions may also apply to a system with multiple processors and multiple machine-readable storage mediums. In such examples, the computing device 302 may be distributed across multiple machine-readable storage mediums and the computing device 302 may be distributed across multiple processors. Put another way, the instructions executed by the computing device 302 may be stored across multiple machine-readable storage mediums and executed across multiple processors, such as in a distributed or virtual computing environment.

As illustrated in FIG. 3, the computing device 302 may comprise a processing resource 328, and a memory resource 330 storing machine-readable instructions to cause the processing resource 328 to perform a number of operations related to accessing a control platform. That is, using the processing resource 328 and the memory resource 330, the computing device 302 may access a control platform, among other operations. Processing resource 328 may be a central processing unit (CPU), microprocessor, and/or other hardware device suitable for retrieval and execution of instructions stored in memory resource 330.

The computing device 302 may include instructions 332 stored in the memory resource 330 and executable by the processing resource 328 to receive an access request for a control platform. For example, a user may desire to perform an action with a particular control platform. Computing device 302 can receive an access request including a particular platform among a plurality of control platforms with which an action is desired to be performed, as well as a user identity. A control platform can be a source control and/or version control platform, and/or can be a public or private control platform.

The computing device 302 may include instructions 334 stored in the memory resource 330 and executable by the processing resource 328 to access the control platform. Computing device 302 can access the control platform based on the received access request. For example, in response to a user identity matching user access credentials, computing device 302 can access the control platform specified in the access request.

In some examples, accessing the control platform can include performing an operation using the control platform. For example, an operation can include a CRUD operation, such as create a change request (e.g., create a pull request, patch, code change, etc.), get a status of a change request, delete a change request, and/or update a change request, among other operations.

The computing device 302 may include instructions 336 stored in the memory resource 330 and executable by the processing resource 328 to transmit access description information. Computing device 302 can transmit access description information based on an action performed with the control platform. For example, computing device 302 can create a change request using the control platform and based on computing device 302 creating the change request, computing device 302 can transmit access description information describing the change request.

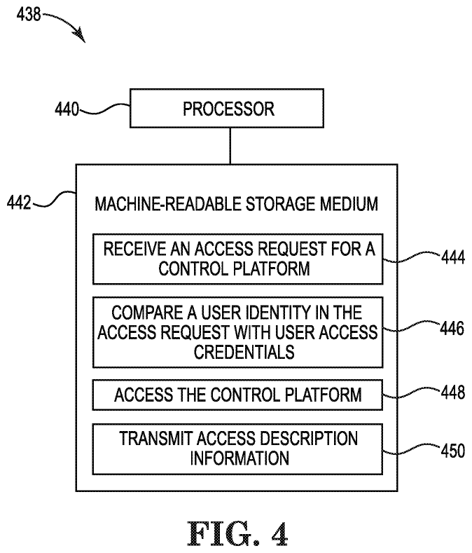

FIG. 4 is a block diagram of an example system 438 consistent with the disclosure. In the example of FIG. 4, system 438 includes a processor 440 and a machine-readable storage medium 442. Although the following descriptions refer to a single processor and a single machine-readable storage medium, the descriptions may also apply to a system with multiple processors and multiple machine-readable storage mediums. In such examples, non-transitory instructions may be distributed across multiple machine-readable storage mediums and the non-transitory instructions may be distributed across multiple processors. Put another way, the non-transitory instructions may be stored across multiple machine-readable storage mediums and executed across multiple processors, such as in a distributed computing environment.

Processor 440 may be a central processing unit (CPU), microprocessor, and/or other hardware device suitable for retrieval and execution of non-transitory instructions stored in machine-readable storage medium 442. In the particular example shown in FIG. 4, processor 440 may receive, determine, and send instructions 444, 446, 448, and 450. As an alternative or in addition to retrieving and executing non-transitory instructions, processor 440 may include an electronic circuit comprising a number of electronic components for performing the operations of the instructions in machine-readable storage medium 442. With respect to the non-transitory executable instruction representations or boxes described and shown herein, it should be understood that part or all of the non-transitory executable instructions and/or electronic circuits included within one box may be included in a different box shown in the figures or in a different box not shown.

Machine-readable storage medium 442 may be any electronic, magnetic, optical, or other physical storage device that stores executable instructions. Thus, machine-readable storage medium 442 may be, for example, Random Access Memory (RAM), an Electrically-Erasable Programmable Read-Only Memory (EEPROM), a storage drive, an optical disc, and the like. The executable instructions may be “installed” on the system 438 illustrated in FIG. 4. Machine-readable storage medium 442 may be a portable, external or remote storage medium, for example, that allows the system 438 to download the instructions from the portable/external/remote storage medium. In this situation, the executable instructions may be part of an “installation package”. As described herein, machine-readable storage medium 442 may be encoded with executable instructions for accessing a control platform.

Receive instructions 444, when executed by a processor such as processor 440, may cause system 438 to receive an access request for a control platform. For example, a user may desire to perform an action with a particular control platform. System 438 can receive an access request including a particular platform among a plurality of control platforms with which an action is desired to be performed, as well as a user identity.

Compare instructions 446, when executed by a processor such as processor 440, may cause system 438 to compare a user identity included in the access request with user access credentials. For example, user access credentials can include a user's username, password, identifying information of the user of a computing device, information identifying the computing device itself, and/or combinations thereof, among other types of user access credentials.

Access instructions 448, when executed by a processor such as processor 440, may cause system 438 to access the control platform. System 438 can access the control platform based on the received access request. For example, in response to a user identity matching user access credentials, system 438 can access the control platform specified in the access request.

In some examples, accessing the control platform can include performing an operation using the control platform. For example, an operation can include a CRUD operation, such as create a change request (e.g., create a pull request, patch, code change, etc.), get a status of a change request, delete a change request, and/or update a change request, among other operations.

Transmit instructions 450, when executed by a processor such as processor 440, may cause system 438 to transmit access description information. System 438 can transmit access description information based on an action performed with the control platform. For example, system 438 can create a change request using the control platform, and based on system 438 creating the change request, system 438 can transmit access description information describing the change request.

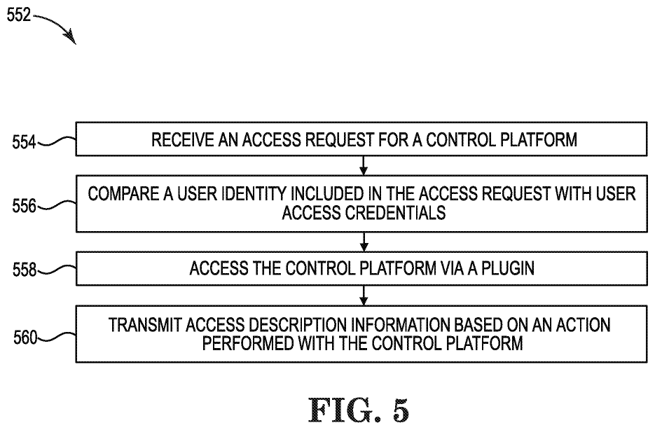

FIG. 5 illustrates an example method 552 consistent with the disclosure. Method 552 may be performed, for example, by a computing device (e.g., computing device 102, 202, 302, previously described in connection with FIGS. 1, 2A, 2B, and 3, respectively).

At 554, the method 552 may include receiving an access request for a control plafform. For example, a computing device can receive an access request for a control platform of a plurality of control platforms. The control platform can be a source control platform and/or a version control platform and can be a public control platform or a private control plafform.

At 556, the method 552 may include comparing a user identity included in the access request with user access credentials. User access credentials can include a user's username, password, identifying information of the user of a computing device, information identifying the computing device itself, and/or combinations thereof, among other types of user access credentials.

At 558, the method 552 may include accessing the control platform. The computing device can access the control platform via a plugin based on the received access request. For example, in response to a user identity matching user access credentials, the computing device can access the control platform specified in the access request.

At 560, the method 552 may include transmitting access description information. The computing device can transmit access description information based on an action performed with the control platform. For example, the computing device can create a change request using the control platform and based on the computing device creating the change request, the computing device can transmit access description information describing the change request.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure.

The figures herein follow a numbering convention in which the first digit corresponds to the drawing figure number and the remaining digits identify an element or component in the drawing. Similar elements or components between different figures may be identified by the use of similar digits. For example, 102 may reference element “02” in FIG. 1, and a similar element may be referenced as 302 in FIG. 3. Elements shown in the various figures herein can be added, exchanged, and/or eliminated so as to provide a plurality of additional examples of the disclosure. In addition, the proportion and the relative scale of the elements provided in the figures are intended to illustrate the examples of the disclosure, and should not be taken in a limiting sense. As used herein, “a plurality of” an element and/or feature can refer to more than one of such elements and/or features.

What is claimed:

1. A computing device, comprising:
a processing resource; and
a memory resource storing non-transitory machine-readable instructions to cause the processing resource to:
receive an access request for a control platform of a plurality of control platforms;
access the control platform based on the received access request; and
transmit access description information based on an action performed with the control platform.

2. The computing device of claim 1, including instructions to cause the processing resource to access the control platform via a plugin.

3. The computing device of claim 2, wherein:
the plugin is a plug-in among a plurality of plugins; and
each plugin of the plurality of plugins corresponds to a control platform of the plurality of control platforms.

4. The computing device of claim 1, including instructions to cause the processing resource to access the control platform via a webhook.

5. The computing device of claim 4, wherein:
the webhook is a webhook among a plurality of webhooks; and
each webhook of the plurality of webhooks corresponds to a control platform of the plurality of control platforms.

6. The computing device of claim 1, wherein the access request includes the control platform among the plurality of control platforms to which the action is to be performed.

7. The computing device of claim 1, including instructions to cause the processing resource to compare a user identity included in the access request with user access credentials.

8. The computing device of claim 7, including instructions to cause the processing resource to access the control platform in response to the user identity matching the user access credentials.

9. The computing device of claim 1, including instructions to cause the processing resource to store the access description information in a database.

10. The computing device of claim 9, including instructions to cause the processing resource to access the stored access description information in the database in response to the computing device receiving a further access request that is a same request as the access request.

11. A non-transitory computer readable medium storing instructions executable by a processing resource to cause the processing resource to:
receive an access request for a control platform of a plurality of control platforms;
compare a user identity included in the access request with user access credentials;
access the control platform based on:
the user identity matching the user access credentials; and
the received access request; and
transmit access description information based on an action performed with the control platform.

12. The medium of claim 11, wherein the control platform is a source control platform.

13. The medium of claim 12, wherein the source control platform is at least one of:
a public source control platform; and
a private source control platform.

14. The medium of claim 11, wherein the control platform is a version control platform.

15. The medium of claim 14, wherein the version control platform is at least one of:
a public version control platform; and
a private version control platform.

16. A method, comprising:
receiving, by a computing device from a user computing device, an access request for a control platform of a plurality of control platforms, wherein the control platform is at least one of a source control platform and a version control platform;
comparing, by the computing device, a user identity included in the access request with user access credentials;
accessing, by the computing device, the control platform via a plugin based on:
the user identity matching the user access credentials; and
the received access request; and
transmitting, by the computing device, access description information based on an action performed with the control platform.

17. The method of claim 16, wherein the method includes receiving, by the computing device, the access request via an application programming interface (API).

18. The method of claim 16, wherein the method includes receiving, by the computing device, the access request via a command received by a user interface of a user computing device.

19. The method of claim 16, wherein accessing the control platform via the plugin includes performing, by the computing device, a create, read, update, or delete (CRUD) operation.

20. The method of claim 19, wherein performing a CRUD operation includes at least one of:
showing activities of the control platform;
creating a change request;
getting a status of the change request;
deleting a change request; and
updating a change request.
